(19) United States
(12) Patent Application Publication
(10) Pub. No.: US 2008/0196673 A1
(43) Pub. Date: Aug. 21, 2008

(54) Magnetic cage

(76) Inventors: Ariel S. Cudia, Arlington Heights, IL (US); Anthony M. Tiskevch, Harvard, IL (US)

Correspondence Address: SARJU R. BHARUCHA, P.O. BOX 3932, NAPERVILLE, IL, 60567, US

(21) Appl. No.: 11/824,217

(22) Filed: Jun. 29, 2007

Related U.S. Application Data
(60) Provisional application No. 60/902,250, filed on Feb. 20, 2007.

(51) Int. Cl. A01K 1/02

(52) U.S. Cl. 119/473; 119/474; 52/582.1

(57) ABSTRACT

A strong and secure magnetic cage framed in a lightweight material such as aluminum with a plastic polymer bottom and detachable panels allowing for an innovative and versatile cage construction. All detachable panels work to secure the caged animal with strong yet lightweight material preventing escape while keeping with the lightweight intent for the design. The cage includes a screened front region with a hinged door structure. The door includes an integrated knob with a locking mechanism. The front region is completed by a detachable screened support panel to further secure the animal. The frame is secured with high-powered magnets housed in plastic connectors with protruding pegs reinforcing the connection between the screened panels. This assembly also encloses and secures the plastic polymer bottom. This invention is easy to clean, store and transport because of its lightweight materials and fully detachable design.

### BACKGROUND OF THE INVENTION

A. Field of Invention

The present invention relates generally to a pegged and magnetically reinforced cage with fully detachable panels.

B. Background

The current state of the art in cages exhibits a lack of portability because of heavy weight and bulk due to poor construction. While collapsibility aides in portability; it does not solve for the heavy weight and bulk in the geometry of the cage. The present invention solves for issues related to weight and bulk by utilizing lightweight material for the fully detachable panels which allows for full disassembly.

Moreover, the current state of the art is restricted in design and function. The present invention utilizes an interchangeable connector system that can be constructed of different lightweight materials varying in color and creating different shapes. Insofar as the present invention is easily disassembled it remains a strong and highly rigid functional cage when fully constructed.

U.S. Pat. No. 6,854,425 discloses a paper pet house made from a paper structure reinforced with ribs. The invention claims enhanced rigidity. However, the reinforcement lies in the lateral walls. This does not create a strong structure.

The present invention is made of durable materials such as aluminum and plastic producing a solid structure with increased longevity. Furthermore, the high-powered magnets, pegs and plastic connectors are placed on every corner and wall of the cage creating a fully reinforced frame.

U.S. Pat. No. 6,192,834 discloses a collapsible cage which claims a portable structure that can be collapsed or expanded quickly. The entire structure is made from a wire frame and accordion walls. However, the cage may not be structurally sound and may allow distressed animals to break free. Furthermore, a collapsible cage may impede the cleaning process because not all walls and panels can be removed for complete access.

In the present invention the fully detachable panels allow for a quick and simple disassembly as well as assembly. In addition, since the panels are fully detachable, they can be easily accessed for thorough cleaning. The use of varied materials in the panels such as screens or plastic polymer in the present invention allows for increased security of animals of all sizes eliminating the possibility for escape through open expandable spaces. Furthermore, the reinforcing peg and magnet connectors provide a strong and stabilized environment for most animals.

These and other functions of the invention will be more apparent from the following summary and detailed description of a preferred embodiment of the present invention.

### SUMMARY OF THE INVENTION

In accordance with one form of this invention, the fully detachable magnetic cage is framed in aluminum. The side and top panels are substantially screen material consistent with the lightweight design. The first panel consists of a door with hinges to allow for the loading and unloading of the pet. The door is screen material with a knob and lock to secure the door framed in aluminum. The aluminum frame and screen material are mold and rust proof. The floor of the cage is a plastic polymer material.

All panels are bonded with high-powered magnets. Each magnet is housed in a plastic connector with a protruding peg located at the corner of each panel. The magnets act as reinforcement buttressing the structure aiding in its stability. The plastic connectors with peg are two-pronged with an open casing to house the high-powered magnets. The pegs provide increased rigidity in the overall structure.

Each panel is fully detachable and individually removable for easy cleaning without having to collapse the entire cage. All panels detach for full disassembly of the structure for easy storage and portability.

These and other features of the invention will be described in further detail in the following detailed description of a presently preferred embodiment.

### BRIEF DESCRIPTION OF THE DRAWINGS

In the following description, references will be made to the appended drawings, where like reference numerals refer to like elements in the various figures, and wherein:

FIG. 1 is a diagram illustrating a fully assembled perspective view of a model of the present invention;

FIG. 2 is an exploded view of the structural components of FIG. 1;

FIG. 3 is an illustration of the front panel showing the latch, knob, and hinges and an illustration of the back panel;

FIG. 4 illustrates the front panel assembly showing the magnet and plastic connectors;

FIG. 5 illustrates the top view showing the magnetic points that connect the front panel, back panel, and side panels;

FIG. 6 illustrates a perspective view of the magnet placements for the plastic polymer bottom;

FIG. 7 illustrates a perspective view of the screen frame; and

FIG. 8 illustrates a perspective view of the square cut screen corner shown in FIG. 1.

### DETAILED DESCRIPTION OF THE PREFERRED EMBODIMENT OF THE INVENTION

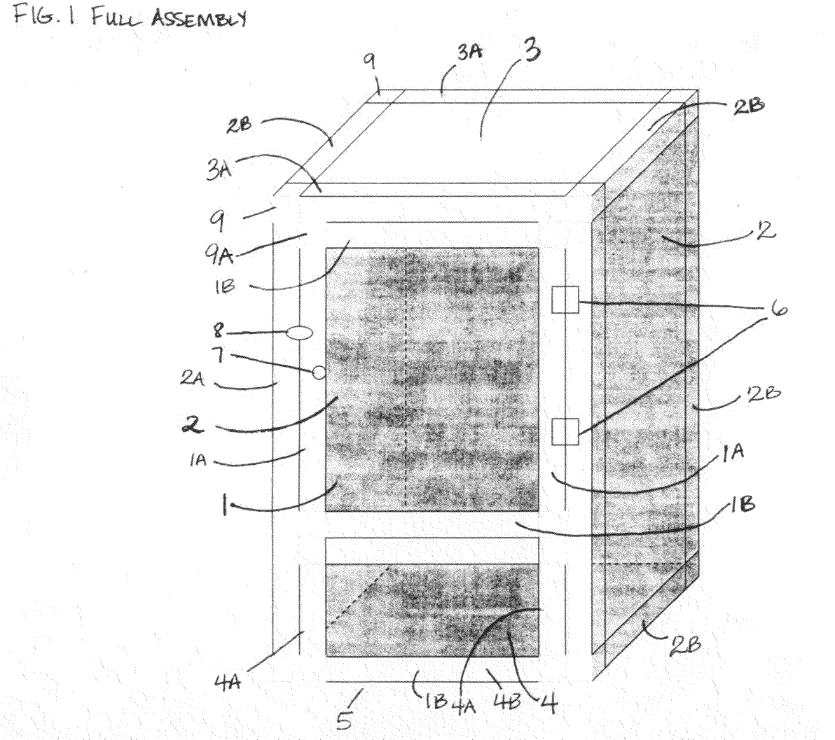

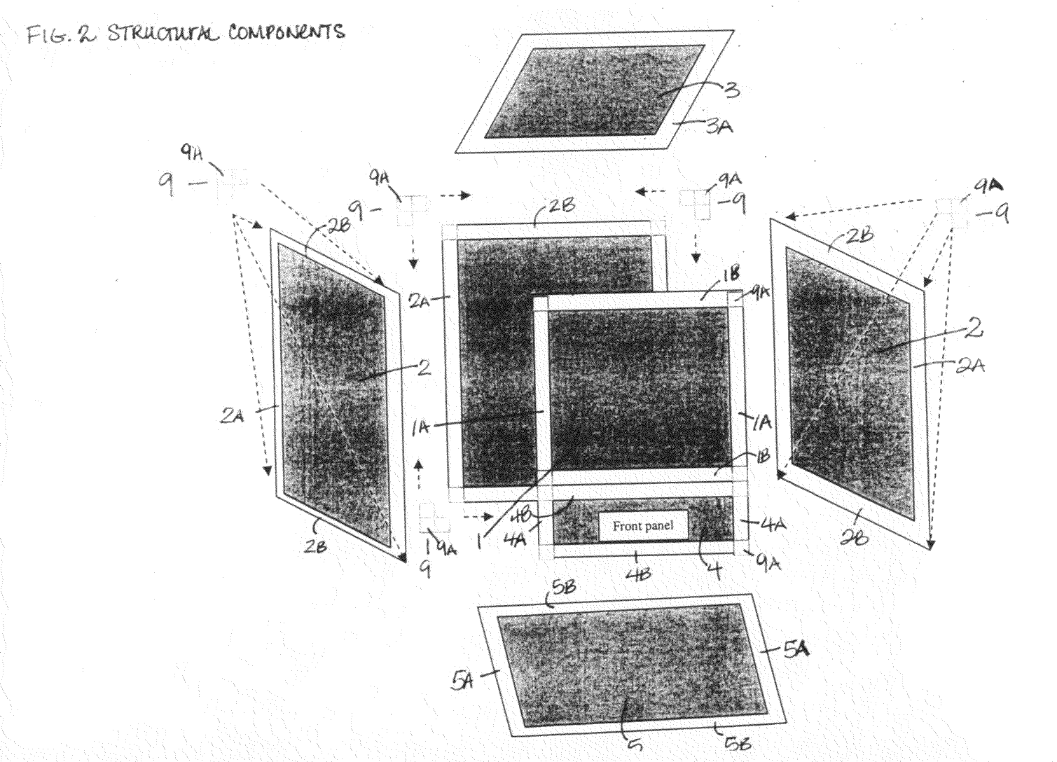

FIG. 1 is the forward perspective view of a magnetic pet cage. FIG. 2 is the exploded view of the structural components of the present invention. In FIG. 2, each vertical panel consists of a screen 2 and two vertical aluminum slats 2A as well as two horizontal slats on the top and bottom of the horizontal slats 2B. Each one of the vertical and horizontal aluminum slats is connected to one side of a plastic connector 9. In each plastic connector 9 there is a casing 9A to house the high-powered magnet 10.

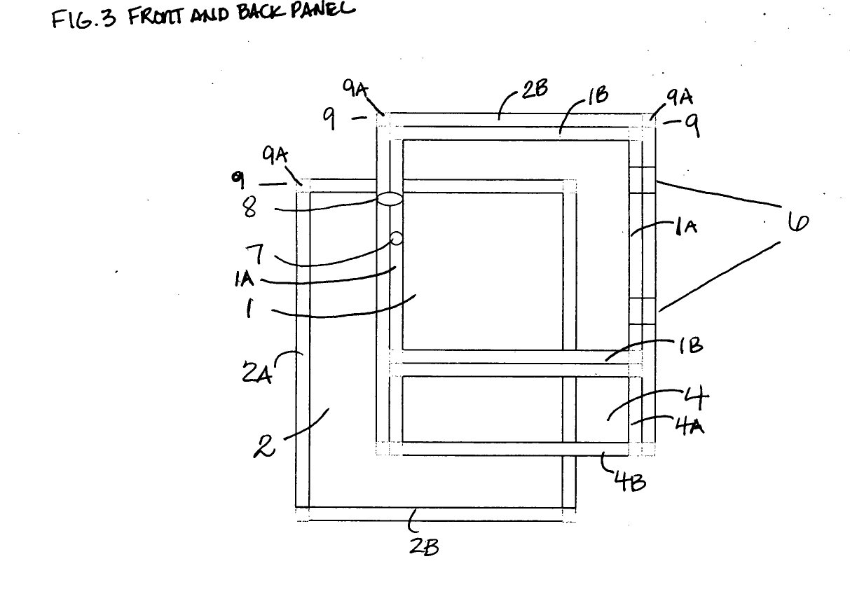

In FIG. 2 each vertical panel consisting of screen 2, two vertical aluminum slats 2A and two horizontal aluminum slats 2B are the same for the two side and the back panels. FIG. 3 displays the front and back panel of the magnetic pet cage. The front panel includes a door consisting of a screen 1 and vertical aluminum slats 1A and horizontal slats 1B. The door further includes two hinges 6 a knob 7 and latch 8. The front panel further consists of a front panel assembly.

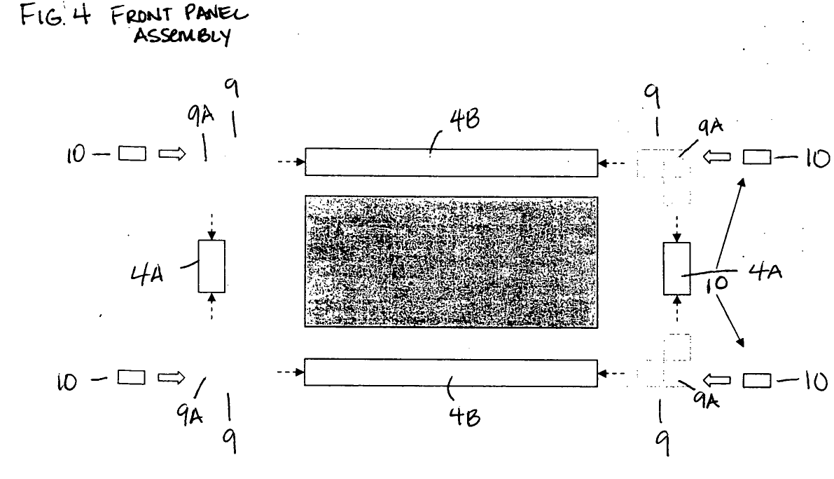

FIG. 4 displays the front panel assembly including a screen 4, vertical aluminum slats 4A and horizontal aluminum slats 4B. A vertical aluminum slat 4A and a horizontal aluminum slat 4B are bonded with one two-prong plastic connector 9 and secured with a high-powered magnet 10 which is encased in the housing 9A within the plastic connector 9.

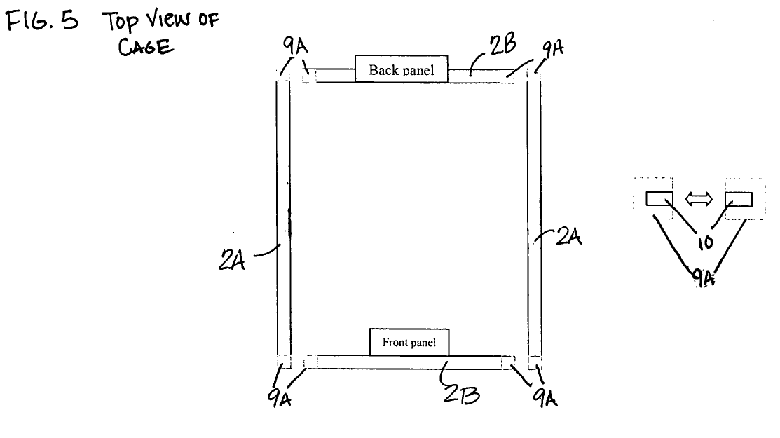

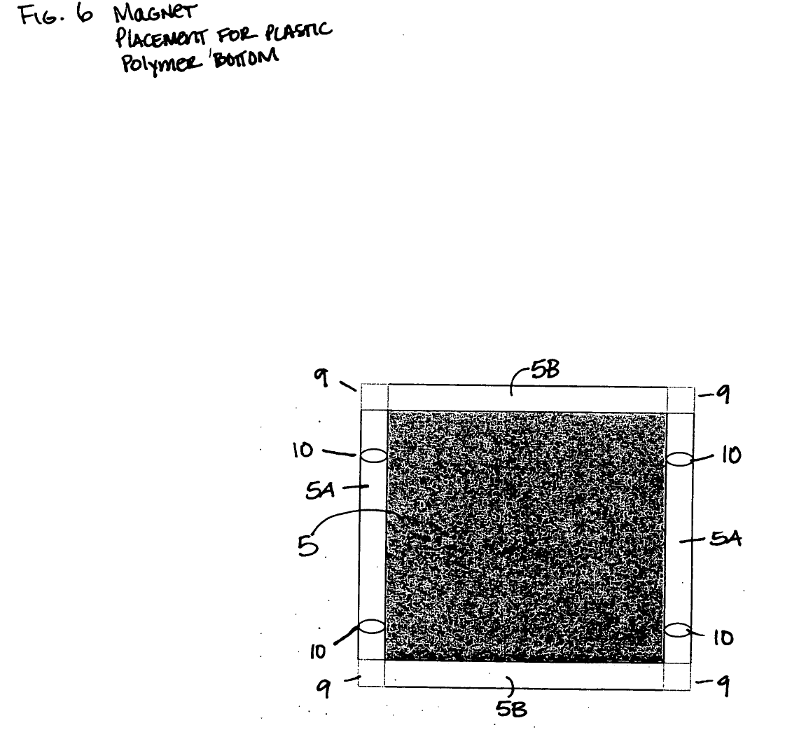

FIG. 5 provides a top view of the magnetic pet cage displaying the relationship of the vertical aluminum slats 2A to the horizontal aluminum slats 2B. The position of the plastic connectors 9 with the encased magnets 10 can also be seen in FIG. 5. FIG. 6 shows the placement of the magnets 10 in the vertical aluminum slats 5A and the horizontal aluminum slats 5B for the plastic polymer bottom 5.

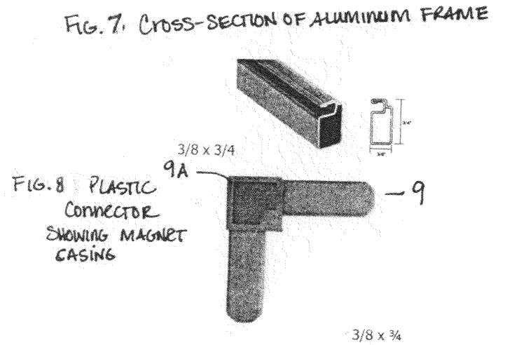

FIG. 7 displays the form of the aluminum slats used to frame each screen. FIG. 8 exhibits a plastic connector 9 and the housing 9A for the magnet.

We claim:

1. A fully detachable magnetic cage, comprising in combination:
a top and bottom panel assembly;
a front and rear panel assembly;
side panel assemblies;
and door panel assembly.

2. The structure as recited in claim 1, further comprising a front region including a door assembly with latch; and said front panel assembly.

3. The structure as recited in claim 1, wherein said panel assembly consists of slats affixed by connectors.

4. The structure as recited in claim 1, wherein said panel assembly comprises horizontal and vertical slats alternating in adjacent positions to encase a material to complete said panel assembly.

5. The connectors as recited in claim 3, wherein said connectors comprise a casing with high-powered magnet, protruding peg and opening to receive said peg from adjacent connector affixed to adjacent slat to secure said panel assemblies to each other.

6. The structure as recited in claim 1, further comprising said bottom panel assembly including a polymer material floor affixed with a plurality of bolts.

7. The structure as recited in claim 1, further comprising:
Said bottom panel assembly first attached to said rear panel assembly secured with the introduction of said connectors, alignment of said pegs to said openings reinforced with pull of said high-powered magnets; said front panel assembly is then introduced to bottom panel opposite said rear panel on said front region of structure and secured with the introduction of said connectors, alignment of said pegs to said openings reinforced with pull of said high-powered magnets; said side panels are then introduced opposite each other and adjacent to said rear, front and bottom panel assemblies secured with the introduction of said connectors, alignment of said pegs to said openings reinforced with pull of said high-powered magnets; said door assembly is then inserted into top horizontal slat of said front panel assembly and secured with the introduction of said connectors, alignment of said pegs to said openings reinforced with pull of said high-powered magnets; said top panel assembly is then introduced opposite said bottom panel assembly affixed to the top horizontal slat of said side panel assemblies, said rear panel assembly and said door panel assembly secured with the introduction of said connectors with alignment of said pegs to said openings reinforced with pull of said high-powered magnets to enclose the structure recited in claim 1.

8. The structure as recited in claim 1 wherein said front, top, bottom, and side panels are detachable and reinforced with high-powered magnets to fully secure assembled structure as recited in claim 1.
